(19) United States
(12) Patent Application Publication
(10) Pub. No.: US 2023/0171585 A1
(43) Pub. Date: Jun. 1, 2023

(54) Device-to-Device Secure Embedded Subscriber Identity Module Subscription Transfer

(71) Applicant: Apple Inc., Cupertino, CA (US)

(72) Inventors: Jean-Marc Padova, San Francisco, CA (US); Hyewon Lee, Cupertino, CA (US); Li Li, Saratoga, CA (US); Raj S. Chaugule, Santa Clara, CA (US); Xiangying Yang, Cupertino, CA (US)

(21) Appl. No.: 18/072,536

(22) Filed: Nov. 30, 2022

Related U.S. Application Data
(60) Provisional application No. 63/285,059, filed on Dec. 1, 2021.

(51) Int. Cl. H04W 8/18; H04W 8/20

(52) U.S. Cl. CPC H04W 8/183; H04W 8/205

(57) ABSTRACT

Systems and methods for facilitating transfer of an eSIM subscription from a source device to a target device. In one embodiment, a source device includes a transceiver and a processor system. The processor system includes an eUICC configured to store an eSIM associated with an eSIM subscription. The processor system is configured to transmit, via the transceiver and to an eSIM subscription manager server, a request for an eSIM subscription transfer activation code; receive, via the transceiver and at least partly in response to the request, a server nonce; generate a signed payload using the server nonce and source device information; transmit, via the transceiver and to the eSIM subscription manager server, the signed payload; receive, via the transceiver and in response to transmitting the signed payload, the eSIM subscription transfer activation code; and provide the eSIM subscription transfer activation code to the target device or a user thereof.

### CROSS-REFERENCE TO RELATED APPLICATION

This application is a nonprovisional and claims the benefit under 35 U.S.C. § 119(e) of U.S. Provisional Patent Application No. 63/285,059, filed Dec. 1, 2021, the contents of which are incorporated herein by reference as if fully disclosed herein.

### TECHNICAL FIELD

This application relates generally to wireless communication systems and, more particularly, to securing device-to-device embedded subscriber identity module (eSIM) subscription transfers.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIGS. 1A and 1B illustrate a first example flow diagram for performing a device-to-device secure eSIM subscription transfer.

FIGS. 2A and 2B illustrate a second example flow diagram for performing a device-to-device secure eSIM subscription transfer.

FIGS. 3A-3C illustrate a third example flow diagram for performing a device-to-device secure eSIM subscription transfer.

FIG. 4 illustrates a method of a source device (e.g., a UE), for facilitating transfer of an eSIM subscription from the source device to a target device (e.g., another UE), according to an embodiment.

FIG. 5 illustrates a method of a target device (e.g., a UE), for facilitating transfer of an eSIM subscription from a source device (e.g., another UE) to the target device, according to an embodiment.

FIG. 6 illustrates a method of an eSIM subscription manager server (e.g., an SM-DP+), for facilitating transfer of an eSIM subscription from a source device (e.g., a first UE) to a target device (e.g., a second UE), according to an embodiment.

FIG. 7 illustrates an example architecture of a wireless communication system, according to embodiments disclosed herein.

FIG. 8 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

A UE has traditionally utilized a subscriber identity module (SIM) to communicate with the base stations and central network of a mobile network operator (MNO). More recently, a UE may be able to utilize an eSIM to communicate with the base stations and central network of an MNO. An eSIM is a digital SIM that can be downloaded and installed on an embedded universal integrated circuit card (eUICC) within a UE. An eSIM may be identified by an integrated circuit card identifier (ICCID).

An eUICC is a hardware component (e.g., a silicon hardware component) that may be permanently integrated into a UE or, alternatively, removably inserted into a UE. An eUICC may be identified by an embedded identity document (EID). An eUICC may host one or multiple (i.e., two or more) eSIMs.

A subscription manager−data preparation+(SM−DP+) server may be deployed by an MNO or cellular carrier to vend eSIMs to the eUICCs of UEs.

The Global System for Mobile Communications Association (GSMA) is an industry organization that represents the interests of MNOs worldwide. The GSMA, in part, helps standardize the operations for vending eSIMs to eUICCs.

At times, an owner or user of a UE may want to move an eSIM subscription from one UE (a source device) to another UE (a target device). For example, an owner or user of a UE may want to move an eSIM subscription from an old device to a new device (e.g., from an old phone to a new phone). The GSMA supports two paths for transferring an eSIM subscription from one UE (a source device) to another device (a target device). The first path allows a cellular carrier to issue a new eSIM/ICCID to the target device and then transfer an eSIM subscription associated with an eSIM of the source device to the eSIM of the target device. The second path allows a cellular carrier to use the same eSIM/ICCID for the source and target devices. For the second path, the source device has to delete the eSIM/ICCID from the source device before the eSIM/ICCID is installed on the target device. Currently, the GSMA specification version 3 (V3) that describes device-to-device eSIM subscription transfers does not describe any sort of security beyond for an eSIM subscription transfer (other than existing client/server authentication). Further, and in the case of a subscription swap (i.e., the use of the same eSIM/ICCID for both the source device and the target device), the GSMA specification V3 does not describe any sort of gating event or notification that indicates when the eSIM subscription can be safely transferred to the target device.

In the flows and methods described herein, a server nonce may be added to the eSIM subscription transfer process to guard against replay attacks. Also, eUICC-based security may be added to the eSIM subscription transfer process. In accord with the eUICC-based security, the eUICC of a source device may generate a signed payload using an ICCID of the source device (i.e., an ICCID of an eSIM installed on the source device) and, optionally, an EID of a target device (i.e., an EID of the eUICC of the target device). The signed payload may then be sent to an SM-DP+ for verification.

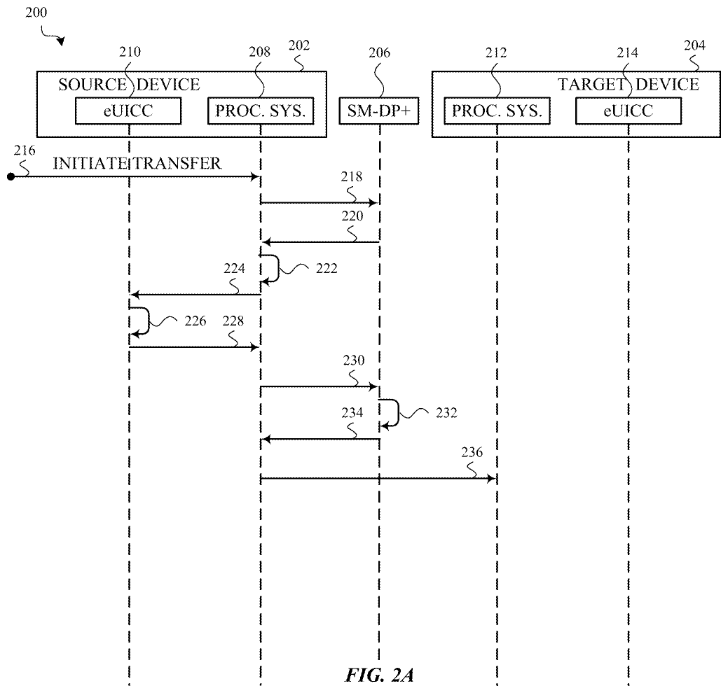

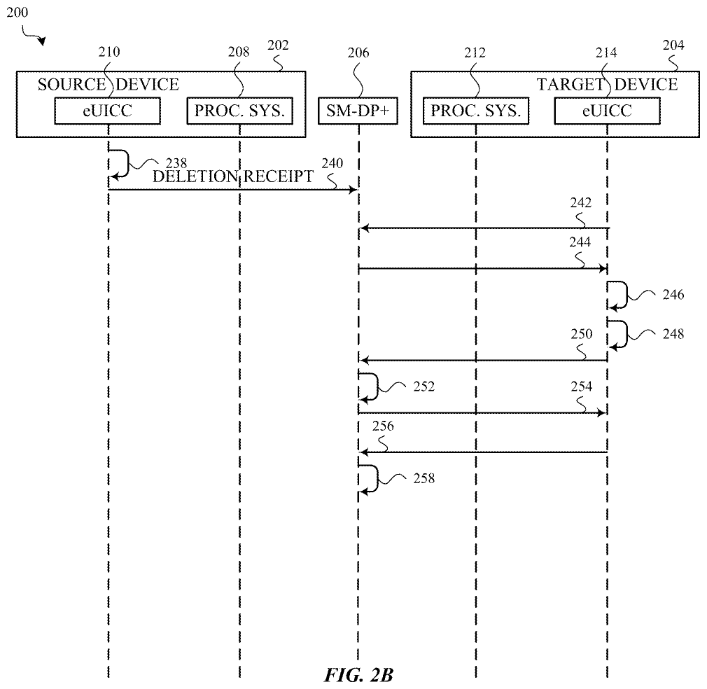

In the flow described with reference to FIGS. 2A and 2B, a user-provided confirmation code (or secret) may be transmitted to the SM-DP+ as part of, or along with, the signed payload. In some cases, a hash of the confirmation code may be transmitted to the SM-DP+. The confirmation code can enable the source device to be offline when the target device is set up, and can be used to secure the eSIM subscription transfer activation code.

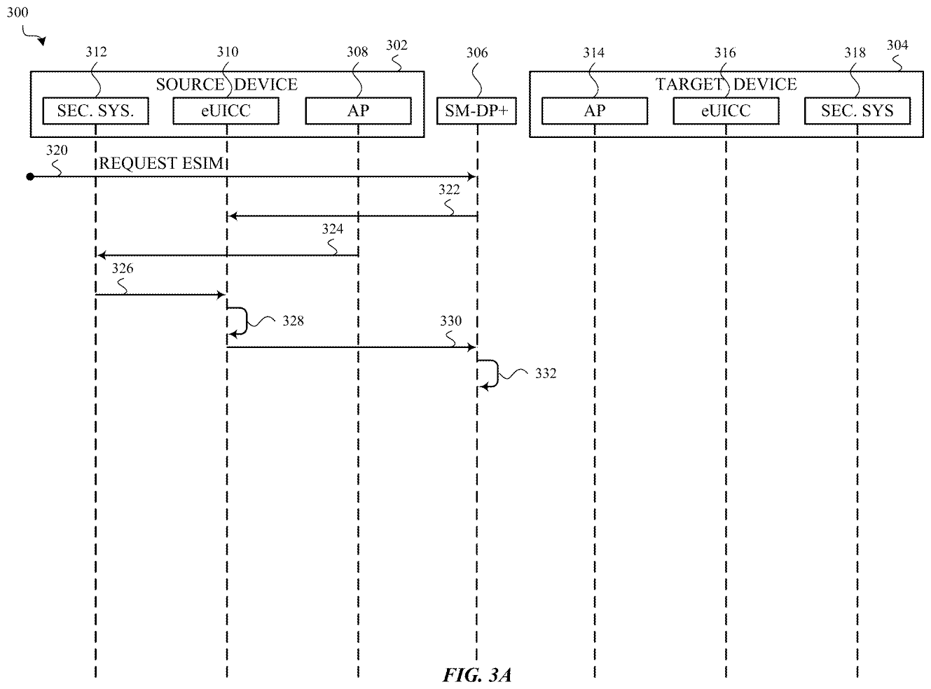

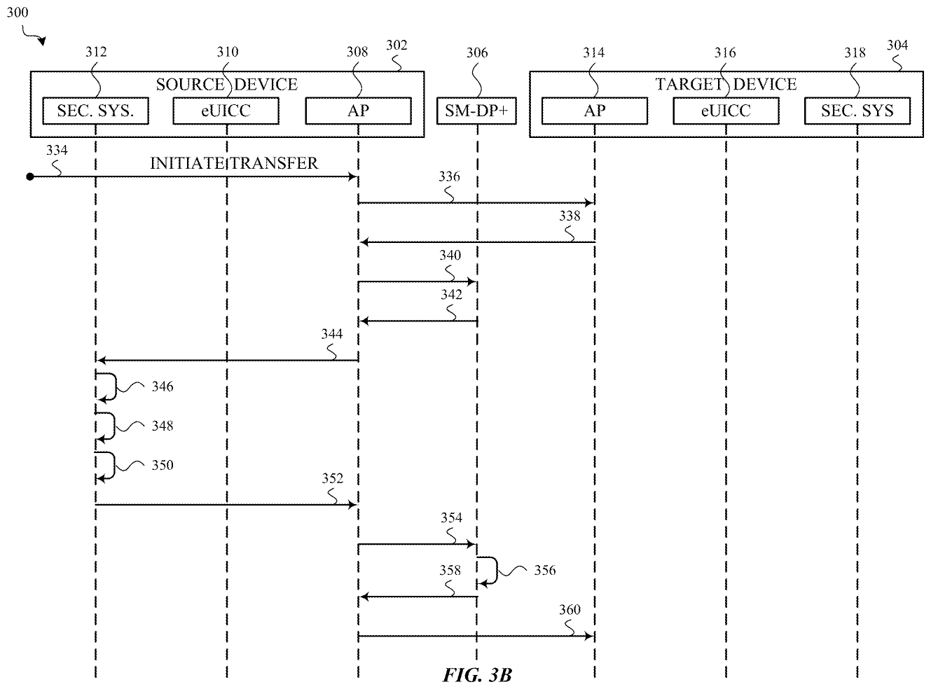

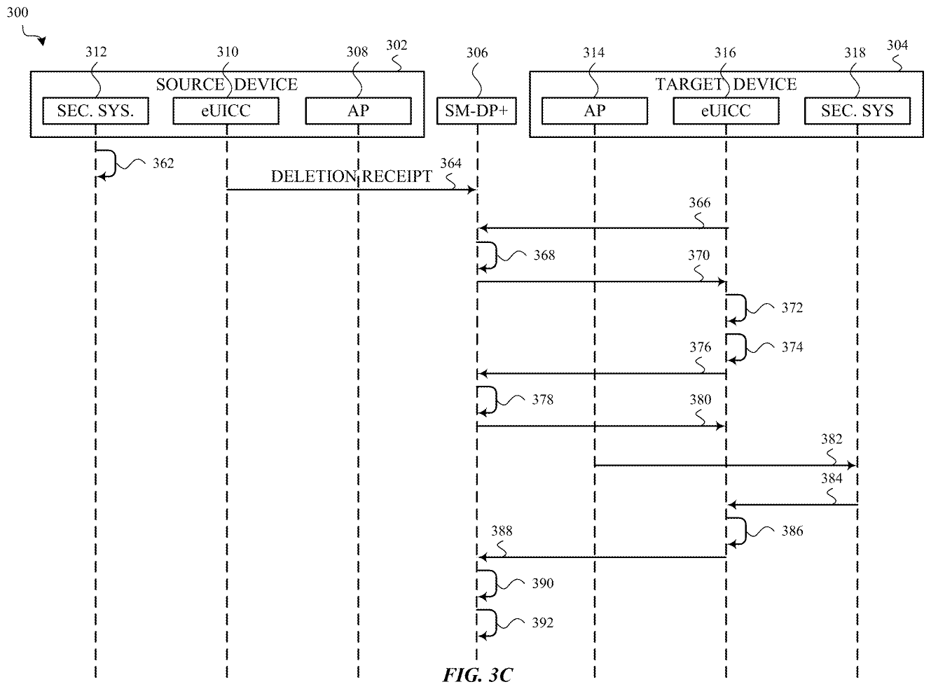

In the flow described with reference to FIGS. 3A-3C, an entity external to the eUICC (e.g., a secure processor subsystem, such as a secure enclave or trusted execution environment (TEE)) may be used to authorize an eSIM subscription transfer. This puts the root of trust for the eSIM subscription transfer outside of the eUICC, and lets the eUICC provide the SM-DP+ with an attestation of the secure entity that can later be used to authenticate an eSIM subscription transfer. The attestation may be provided to the SM-DP+ during the initial install of the eSIM on the source device, at a time when the source device is presumably secure.

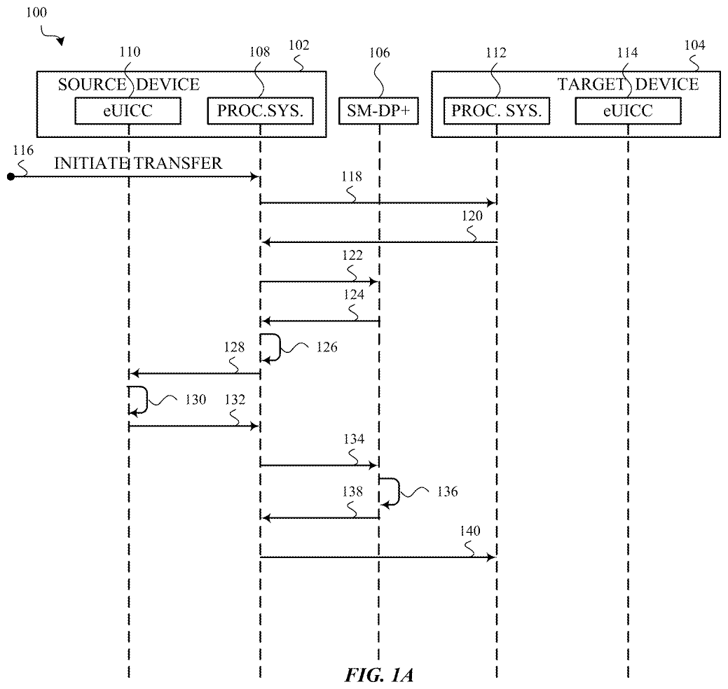

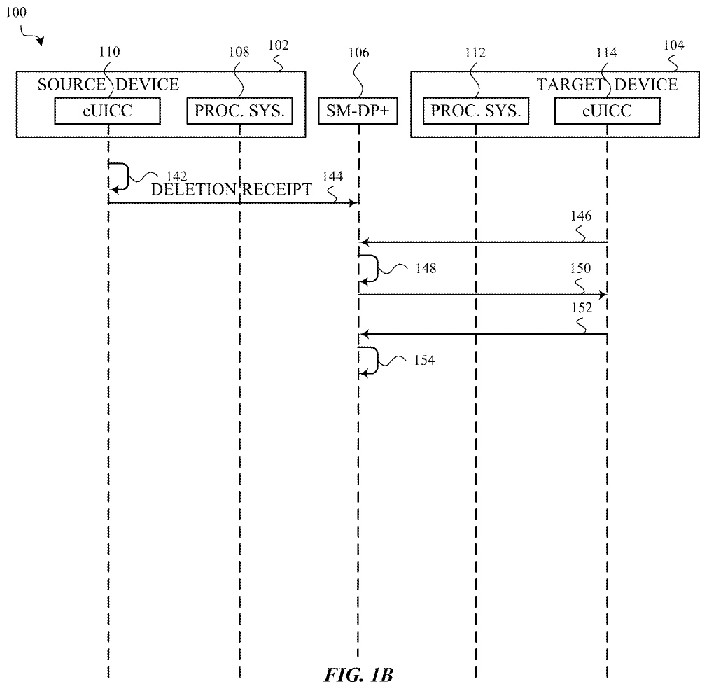

FIGS. 1A and 1B illustrate a first example flow diagram 100 for performing a device-to-device secure eSIM subscription transfer. By way of example, an eSIM subscription may be transferred from a source device 102 (e.g., a first UE) to a target device 104 (e.g., a second UE) with the assistance of an eSIM subscription manager server 106 (e.g., an SM-DP+ server).

The source device 102 may include a processor system 108. The processor system 108 may include one or more hardware components (e.g., one or more silicon hardware components), and in some cases may include one or more of an applications processor, an eUICC 110, a secure processor subsystem, and so on. The eUICC 110 may be or include a hardware component (e.g., a silicon hardware component) that is configured to host one or more eSIMs. The eUICC 110 may be identified by an EID of the source device 102 (and more particularly, an EID of the eUICC 110). The source device 102 may also include other components, such as one or more transceivers (e.g., a cellular radio transceiver, a short-range wireless communication transceiver (e.g., a BLUETOOTH® transceiver), a Wi-Fi transceiver, and so on), a display, a camera, and so on.

The target device 104 may include a processor system 112, and/or other components, which in some cases may be configured similarly to similar components included in the source device 102. The processor system 112 may include an eUICC 114. In most cases, the source device 102 and the target device 104 will be devices that are at least temporarily (or at some time) owned, operated, or managed by the same user (e.g., a person) or entity (e.g., a business or organization).

The eSIM subscription manager server 106 may be operated by a mobile network operator (MNO) or other entity, and may vend eSIMs to eUICCs. Each eSIM may be associated with an eSIM subscription that is managed by the eSIM subscription manager server 106.

At 116, a user or computer process may initiate a device-to-device eSIM subscription transfer. The transfer may be initiated by a user, for example, by providing user input to an eSIM subscription transfer utility, by scanning a quick response (QR) code, or by other means. The user input, scanned QR code, or other input may be provided to the processor system 108.

In response to the eSIM subscription transfer process being initiated, the processor system 108 may obtain (e.g., request and receive) information about the target device 104 (i.e., target device information) at 118 and 120. The target device information may include an EID of the target device 104 and, more particularly, the EID of the eUICC 114 of the target device 104. In some embodiments, the processor system 108 may operate a camera of the source device 102 and prompt a user to scan the EID of the eUICC 114 (or a QR code in which the EID is encoded) at 118. Alternatively, the processor system 112 may operate a short-range wireless communication transceiver (e.g., a BLUETOOTH® transceiver) of the source device 102 and transmit to the target device 104, via the short-range wireless communication transceiver, a request for the EID. At 120, the source device 102 may receive an image of the EID, an image of a QR code in which the EID is encoded, or a message from the target device 104 including the EID. The EID and/or other target device information may alternatively be obtained by the source device 102 in other ways.

At 122, the processor system 108 of the source device 102 may transmit, via a transceiver of the source device 102 and to the eSIM subscription manager server 106, a request for an eSIM subscription transfer activation code. After receiving the request for the eSIM subscription transfer activation code, and at least partly in response to receiving the request, the eSIM subscription manager server 106 may transmit a server nonce to the source device 102 at 124.

The processor system 108 of the source device 102 may receive the server nonce via a transceiver of the source device 102 and, at 126, optionally prompt the user of the source device 102 to confirm that the server nonce received at 124 should be used. In some cases, the source device 102 may prompt the user for a confirmation code and/or a mechanical input (e.g., a button press or double-press). The confirmation code may take the form of a user password, a biometric (e.g., a scan of a body part such as a finger, face, or retina), and so on. The mechanical input may be useful in that it cannot be easily spoofed by a software process.

At 128, the server nonce may be transferred from an application processor of the processor system 108 to the eUICC 110. After receiving the server nonce and the optional confirmation code and/or mechanical input, and at least partly in response to receiving the server nonce and optional confirmation code and/or mechanical input, the eUICC 110 may generate a signed payload using the server nonce and source device information at 130. The source device information may in some cases include an ICCID of the source device 102 (e.g., an ICCID of an eSIM hosted by the eUICC 110). In some embodiments, the signed payload may also be generated using target device information, such as the EID of the target device 104. At 132, the signed payload may be transferred to the application processor of the processor system 108. The eUICC-signed payload provides an extra layer of security to make sure that the eSIM subscription manager server is transferring the eSIM subscription transfer activation code to a proper entity.

At 134, the processor system 108 of the source device 102 may transmit the signed payload to the eSIM subscription manager server 106 via a transceiver of the source device 102. After receiving the signed payload, and at least partly in response to receiving the signed payload, the eSIM subscription manager server 106 may store the signed payload and/or the server nonce, source device information, and/or target device information at 136, and transmit the eSIM subscription transfer activation code to the source device 102 at 138.

The processor system 108 of the source device 102 may receive the eSIM subscription transfer activation code via a transceiver of the source device 102 and, at 140, the processor system 108 may provide the eSIM subscription transfer activation code to the target device 104 or a user of the target device 104. In some cases, the processor system 108 may provide the eSIM subscription transfer activation code to the target device 104 or its user by wirelessly transferring the eSIM subscription transfer activation code to the target device 104 (e.g., via a short-range wireless communication transceiver), or by displaying the eSIM subscription transfer activation code so that it may be read by the target device 104 or its user, or by displaying a QR code in which the eSIM subscription transfer activation code is encoded. The eSIM subscription transfer activation code may also be provided to the target device 104 or its user in other ways.

When the eSIM subscription manager server 106 provides a new eSIM to the target device 104 as part of the flow shown in FIGS. 1A and 1B, the operations at 142 and 144 may be skipped. Otherwise, when the eSIM subscription manager server 106 transfers the eSIM hosted by the eUICC 110 of the source device 102 to the eUICC 114 of the target device 104, the eUICC 110 of the source device 102 may delete its eSIM at 142 and, at 144, the processor system 108 of the source device 102 may transmit a deletion receipt to the eSIM subscription manager server 106. In some cases, the eSIM subscription manager server 106 may be prohibited from transferring an eSIM from the source device 102 to the target device 104 until it receives a deletion receipt.

After receiving the eSIM subscription transfer activation code at 140, the processor system 112 of the target device 104 may transmit the eSIM subscription transfer activation code to the eSIM subscription manager server 106 at 146. The eSIM subscription transfer activation code may be transmitted via a transceiver of the target device 104. In some cases, the target device 104 may also transmit target device information, such as an EID of the target device 104 (and more particularly, an EID of the eUICC 114) to the eSIM subscription manager server 106. The target device information may be transmitted with the eSIM subscription transfer activation code or in a separate message. When the target device 104 also transmits target device information (e.g., the EID of the eUICC 114) to the eSIM subscription manager server 106, the eSIM subscription manager server 106 may verify the target device information (e.g., the EID of the eUICC 114) at 148. For example, the eSIM subscription manager server 106 may ensure that the EID received from the target device 104 matches an EID of the target device 104 received from the source device 102 at 134. At least partly in response to receiving the eSIM transfer activation code at 140, and in some cases at least partly in response to successfully verifying the target device information (e.g., the EID of the eUICC 114) at 148, the eSIM subscription manager server 106 may transfer an eSIM to the target device 104 at 150.

The eUICC 114 of the target device 104 may install or host the received eSIM and, at 152, the processor system 112 of the target device 104 may transmit a receipt indicating the target device 104 installed the eSIM (e.g., an eSIM install receipt) to the eSIM subscription manager server 106. The install receipt may be transmitted via a transceiver of the target device 104.

At 154, and after receipt of the install receipt at 152, the eSIM subscription manager server 106 may optionally trigger ES2+ service transfer (if a new ICCID was issued). Delaying ES2+service transfer until after the install receipt is received helps prevent a service conflict when duplicate service could potentially be provided through the simultaneous enablement of an eSIM installed on the source device 102 and a new eSIM installed on the target device 104.

FIGS. 2A and 2B illustrate a second example flow diagram 200 for performing a device-to-device secure eSIM subscription transfer. By way of example, an eSIM subscription may be transferred from a source device 202 (e.g., a first UE) to a target device 204 (e.g., a second UE) with the assistance of an eSIM subscription manager server 206 (e.g., a subscription manager−data preparation+(SM−DP+) server).

The source device 202 may include a processor system 208. The processor system 208 may include one or more hardware components (e.g., one or more silicon hardware components), and in some cases may include one or more of an applications processor, an eUICC 210, a secure processor subsystem, and so on. The eUICC 210 may be or include a hardware component (e.g., a silicon hardware component) that is configured to host one or more eSIMs. The eUICC 210 may be identified by an EID of the source device 202 (and more particularly, an EID of the eUICC 210). The source device 202 may also include other components, such as one or more transceivers (e.g., a cellular radio transceiver, a short-range wireless communication transceiver (e.g., a BLUETOOTH® transceiver), a Wi-Fi transceiver, and so on), a display, a camera, and so on.

The target device 204 may include a processor system 212 and/or other components, which in some cases may be configured similarly to similar components included in the source device 202. The processor system 212 may include an eUICC 214. In most cases, the source device 202 and the target device 204 will be devices that are at least temporarily (or at some time) owned, operated, or managed by the same user (e.g., a person) or entity (e.g., a business or organization).

The eSIM subscription manager server 206 may be operated by an MNO or other entity, and may vend eSIMs to eUICCs. Each eSIM may be associated with an eSIM subscription that is managed by the eSIM subscription manager server 206.

At 216, a user or computer process may initiate a device-to-device eSIM subscription transfer. The transfer may be initiated by a user, for example, by providing user input to an eSIM subscription transfer utility, by scanning a quick response (QR) code, or by other means. The user input, scanned QR code, or other input may be provided to the processor system 208.

At 218, the processor system 208 of the source device 202 may transmit, via a transceiver of the source device 202 and to the eSIM subscription manager server 206, a request for an eSIM subscription transfer activation code. After receiving the request for the eSIM subscription transfer activation code, and at least partly in response to receiving the request, the eSIM subscription manager server 206 may transmit a server nonce to the source device 202 at 220.

The processor system 208 of the source device 202 may receive the server nonce via a transceiver of the source device 202 and, at 222, optionally prompt the user of the source device 202 to confirm that the server nonce received at 220 should be used. In some cases, the source device 202 may prompt the user for a confirmation code and/or a mechanical input (e.g., a button press or double-press). The confirmation code may take the form of a user password, a biometric (e.g., a scan of a body part such as a finger, face, or retina), and so on. The mechanical input may be useful in that it cannot be easily spoofed by a software process.

At 224, the server nonce may be transferred from an application processor of the processor system 208 to the eUICC 210. After receiving the server nonce and the optional confirmation code and/or mechanical input, and at least partly in response to receiving the server nonce and optional confirmation code and/or mechanical input, the eUICC 210 may generate a signed payload using the server nonce and source device information at 226. The source device information may in some cases include an ICCID of the source device 202 (e.g., an ICCID of an eSIM hosted by the eUICC 210). In some embodiments, the signed payload may also be generated using target device information, such as the EID of the target device 204. Also at 224, the eUICC 210 may generate a hash of the confirmation code received at 222, or the eUICC 210 may generate pseudo-random data in accord with a predetermined algorithm. At 228, the signed payload and hash of the confirmation code (or the pseudo-random data) may be transferred to the application processor of the processor system 208. The eUICC-signed payload provides an extra layer of security to make sure that the eSIM subscription manager server is transferring the eSIM subscription transfer activation code to a proper entity. The hashed confirmation code (or pseudo-random data) provides an extra layer of security in that 1) the confirmation code must be provided to (e.g., input into) the target device 204 before the target device can receive an eSIM subscription transfer, and only a hash of the confirmation code is transferred to and stored on the eSIM subscription manager server 206 (so that a hack of the communication channel between the source device 202 and the eSIM subscription manager server 206, or a hack of the eSIM subscription manager server 206, will not enable the hacker to obtain the confirmation code).

At 230, the processor system 208 of the source device 202 may transmit the signed payload and hash of the confirmation code (or pseudo-random data) to the eSIM subscription manager server 206 via a transceiver of the source device 202. After receiving the signed payload, and at least partly in response to receiving the signed payload, the eSIM subscription manager server 206 may store the signed payload and/or the server nonce, source device information, target device information, hash of the confirmation code, and/or pseudo-random data at 232, and may transmit the eSIM subscription transfer activation code to the source device 202 at 234.

The processor system 208 of the source device 202 may receive the eSIM subscription transfer activation code via a transceiver of the source device 202 and, at 236, the processor system 208 of the source device 202 may provide the eSIM subscription transfer activation code to the target device 204 or a user of the target device 204. In some cases, the processor system 208 may provide the eSIM subscription transfer activation code to the target device 204 or its user by wirelessly transferring the eSIM subscription transfer activation code to the target device 204 (e.g., via a short-range wireless communication transceiver), or by displaying the eSIM subscription transfer activation code so that it may be read by the target device 204 or its user, or by displaying a QR code in which the eSIM subscription transfer activation code is encoded. The eSIM subscription transfer activation code may also be provided to the target device 204 or its user in other ways.

When the eSIM subscription manager server 206 provides a new eSIM to the target device 204 as part of the flow shown in FIGS. 2A and 2B, the operations at 238 and 240 may be skipped. Otherwise, when the eSIM subscription manager server 206 transfers the eSIM hosted by the eUICC 210 of the source device 202 to the eUICC 214 of the target device 204, the eUICC 210 of the source device 202 may delete its eSIM at 238 and, at 240, the processor system 208 of the source device 202 may transmit a deletion receipt to the eSIM subscription manager server 206. In some cases, the eSIM subscription manager server 206 may be prohibited from transferring an eSIM from the source device 202 to the target device 204 until it receives a deletion receipt.

After receiving the eSIM subscription transfer activation code at 236, the processor system 212 of the target device 204 may transmit the eSIM subscription transfer activation code to the eSIM subscription manager server 206 at 242. The eSIM subscription transfer activation code may be transmitted via a transceiver of the target device 204.

At 244, and at least partly in response to receiving the eSIM transfer activation code, the eSIM subscription manager server 206 may transmit, to the target device 204, a request for a confirmation code. At 246, the target device 204 may prompt a user of the target device 204 for the confirmation code. Upon receiving the confirmation code, and at 248, the eUICC 214 of the target device 204 may generate a hash of the confirmation code. Alternatively, the operations at 246 and 248 may be replaced by the eUICC 214 generating pseudo-random data in accord with a predetermined algorithm. At 250, the processor system 212 of the target device 204 may transmit the hash of the confirmation code (or the pseud-random data) to the eSIM subscription manager server 206. The hash of the confirmation code (or pseudo-random data) may be transmitted via a transceiver of the target device 204.

At 252, the eSIM subscription manager server 206 may compare the hash of the confirmation code (or pseudo-random data) received from the source device at 230 (i.e., a first hash or first pseudo-random data) to the hash of the confirmation code (or pseudo-random data) received from the target device at 250 (i.e., a second hash or second pseudo-random data). At least partly in response to receiving the eSIM transfer activation code at 242, and at least partly in response to confirming a match of the second hash to the first hash (or confirming a match of the second pseudo-random data to the first pseudo-random data), the eSIM subscription manager server 206 may transmit an eSIM to the target device 204 at 254.

The eUICC 214 of the target device 204 may install or host the received eSIM and, at 256, the processor system 212 of the target device 204 may transmit a receipt indicating the target device 204 installed the eSIM (e.g., an eSIM install receipt) to the eSIM subscription manager server 206. The install receipt may be transmitted via a transceiver of the target device 204.

At 258, and after receipt of the install receipt at 256, the eSIM subscription manager server 206 may optionally trigger ES2+service transfer (if a new ICCID was issued). Delaying ES2+ service transfer until after the install receipt is received helps prevent a service conflict when duplicate service could potentially be provided through the simultaneous enablement of an eSIM installed on the source device 202 and a new eSIM installed on the target device 204.

FIGS. 3A-3C illustrate a third example flow diagram 300 for performing a device-to-device secure eSIM subscription transfer. By way of example, an eSIM subscription may be transferred from a source device 302 (e.g., a first UE) to a target device 304 (e.g., a second UE) with the assistance of an eSIM subscription manager server 306 (e.g., a subscription manager — data preparation+(SM−DP+) server).

The source device 302 may include a processor system, which processor system may include one or more hardware components (e.g., one or more silicon hardware components), and in some cases may include one or more of an applications processor (AP) 308, an eUICC 310, a secure processor subsystem 312, and so on. The eUICC 310 may be or include a hardware component (e.g., a silicon hardware component) that is configured to host one or more eSIMs. The eUICC 310 may be identified by an EID of the source device 302 (and more particularly, an EID of the eUICC 310). The secure processor subsystem 312 is a subsystem of the processor system, separate from the AP 308 and eUICC 310, that performs computer processes that are not visible to or controllable by (or not fully visible to or controllable by) the AP 308, eUICC 310, or other components of the processor system or source device 302. The source device 302 may also include other components, such as one or more transceivers (e.g., a cellular radio transceiver, a short-range wireless communication transceiver (e.g., a BLUETOOTH® transceiver), a Wi-Fi transceiver, and so on), a display, a camera, and so on.

The target device 304 may include a processor system and/or other components, which in some cases may be configured similarly to similar components included in the source device 302. In some cases, the processor system may include one or more of an AP 314, an eUICC 316, a secure processor subsystem 318, and so on. The eUICC 316 may be identified by an EID of the target device 304 (and more particularly, an EID of the eUICC 316). The target device 304 may also include other components, such as one or more transceivers (e.g., a cellular radio transceiver, a short-range wireless communication transceiver (e.g., a BLUETOOTH® transceiver), a Wi-Fi transceiver, and so on), a display, a camera, and so on. In most cases, the source device 302 and the target device 304 will be devices that are at least temporarily (or at some time) owned, operated, or managed by the same user (e.g., a person) or entity (e.g., a business or organization).

The eSIM subscription manager server 306 may be operated by an MNO or other entity, and may vend eSIMs to eUICCs. Each eSIM may be associated with an eSIM subscription that is managed by the eSIM subscription manager server 306.

At 320, a user or computer process (e.g., the processor system) of the source device 302 may request an eSIM from the eSIM subscription manager server 306. At 322, and at least partly in response to the request, the eSIM subscription manager server 306 may transmit an eSIM associated with an eSIM subscription to the source device 302. The eSIM may be received by the eUICC 310, and may be installed on or hosted by the eUICC 310.

At 324, and subsequent to the eSIM being installed on or hosted by the eUICC 310, the AP 308 may request an eSIM subscription transfer certificate from the secure processor subsystem 312. At least partly in response to the request at 324, the secure processor subsystem 312 may generate the eSIM subscription transfer certificate. At 326, the secure processor subsystem 312 may transmit the eSIM subscription transfer certificate to the eUICC 310; and at 328, the eUICC 310 may sign the eSIM subscription transfer certificate. At 330, the processor system (e.g., the eUICC 310) of the source device 302 may transmit, via a transceiver of the source device 302 and to the eSIM subscription manager server 306, the signed eSIM subscription transfer certificate. At 332, the eSIM subscription manager server 306 may store the eSIM subscription transfer certificate. The eSIM subscription transfer certificate, generated by the secure processor subsystem 312 and signed by the eUICC 310, can be generated right after the eSIM is installed, at a time when the source device 302 is less likely to have been compromised.

At 334, a user or computer process may initiate a device-to-device eSIM subscription transfer. The transfer may be initiated by a user, for example, by providing user input to an eSIM subscription transfer utility, by scanning a quick response (QR) code, or by other means. The user input, scanned QR code, or other input may be provided to the processor system (e.g., the AP 308) of the source device 302.

In response to the eSIM subscription transfer process being initiated, the processor system (e.g., the AP 308) of the source device 302 may optionally obtain (e.g., request and receive) information about the target device 304 (i.e., target device information) at 336 and 338. The target device information may include an EID of the target device 304 and, more particularly, the EID of the eUICC 316 of the target device 304. In some embodiments, the processor system (e.g., the AP 308) of the source device 302 may operate a camera of the source device 302 and prompt a user to scan the EID of the eUICC 316 (or a QR code in which the EID is encoded) at 336. Alternatively, the processor system (e.g., the AP 308) of the source device 302 may operate a short-range wireless communication transceiver (e.g., a BLUETOOTH® transceiver) of the source device 302 and transmit to the target device 304, via the short-range wireless communication transceiver, a request for the EID. At 338, the source device 302 may receive an image of the EID, an image of a QR code in which the EID is encoded, or a message from the target device 304 including the EID. The EID and/or other target device information may alternatively be obtained by the source device 302 in other ways.

At 340, and in response to the eSIM subscription transfer process being initiated, the processor system (e.g., the AP 308) of the source device 302 may transmit, via a transceiver of the source device 302 and to the eSIM subscription manager server 306, a request for an eSIM subscription transfer activation code. After receiving the request for the eSIM subscription transfer activation code, and at least partly in response to receiving the request, the eSIM subscription manager server 306 may transmit a server nonce to the source device 302 at 342.

The processor system (e.g., the AP 308) of the source device 302 may receive the server nonce via a transceiver of the source device 302 and, at 344, send the server nonce, source device information (e.g., an ICCID of the source device 302 (e.g., an ICCID of an eSIM hosted by the eUICC 310)), and the optional target device information (e.g., the EID of the target device's eUICC 316) to the secure processor subsystem 312.

At 346 and 348, the secure processor subsystem 312 may optionally prompt the user of the source device 302 to confirm that the server nonce received at 342 should be used. In some cases, the source device 302 may prompt the user for a confirmation code and/or a mechanical input (e.g., a button press or double-press). The confirmation code may take the form of a user password, a biometric (e.g., a scan of a body part such as a finger, face, or retina), and so on. The mechanical input may be useful in that it cannot be easily spoofed by a software process.

After receiving the server nonce and the optional confirmation code and/or mechanical input, and at least partly in response to receiving the server nonce and optional confirmation code and/or mechanical input, the secure processor subsystem 312 may generate a signed payload using the server nonce and source device information at 350 (e.g., the ICCID of the eSIM hosted by the eUICC 310). In some embodiments, the signed payload may also be generated using target device information, such as the EID of the target device 304. Also at 350, the secure processor subsystem 312 may optionally generate a hash of the confirmation code received at 348, or the secure processor subsystem 312 may optionally generate pseudo-random data in accord with a predetermined algorithm. At 352, the signed payload and optional hash of the confirmation code (or optional pseudo-random data) may be transferred to the AP 308. The secure processor subsystem-signed payload provides an extra layer of security to make sure that the eSIM subscription manager server is transferring the eSIM subscription transfer activation code to a proper entity. The hashed confirmation code (or pseudo-random data) provides an extra layer of security in that 1) the confirmation code must be provided to (e.g., input into) the target device 304 before the target device can receive an eSIM subscription transfer, and only a hash of the confirmation code is transferred to and stored on the eSIM subscription manager server 306 (so that a hack of the communication channel between the source device 302 and the eSIM subscription manager server 306, or a hack of the eSIM subscription manager server 306, will not enable the hacker to obtain the confirmation code).

At 354, the AP 308 of the source device 302 may transmit the signed payload and optional hash of the confirmation code (or optional pseudo-random data) to the eSIM subscription manager server 306. The signed payload and hash of the confirmation code (or optional pseudo-random data) may be transmitted via a transceiver of the source device 302. After receiving the signed payload, the eSIM subscription manager server 306 may store the signed payload and/or the server nonce, source device information, target device information, hash of the confirmation code, and/or pseudo-random data at 356, and may transmit the eSIM subscription transfer activation code to the source device 302 at 358. When the eSIM subscription manager server 306 receives a signed eSIM subscription transfer certificate at 330, the eSIM subscription manager server 306 may verify that the information contained in the eSIM subscription transfer certificate matches information received at 354 before transmitting the eSIM subscription transfer activation code to the source device 302 at 358.

The AP 308 of the source device 302 may receive the eSIM subscription transfer activation code via a transceiver of the source device 302 and, at 360, the AP 308 of the source device 302 may provide the eSIM subscription transfer activation code to the target device 304 or a user of the target device 304. In some cases, the AP 308 may provide the eSIM subscription transfer activation code to the target device 304 or its user by wirelessly transferring the eSIM subscription transfer activation code to the target device 304 (e.g., via a short-range wireless communication transceiver), or by displaying the eSIM subscription transfer activation code so that it may be read by the target device 304 or its user, or by displaying a QR code in which the eSIM subscription transfer activation code is encoded. The eSIM subscription transfer activation code may also be provided to the target device 304 or its user in other ways.

When the eSIM subscription manager server 306 provides a new eSIM to the target device 304 as part of the flow shown in FIGS. 3A-3C, the operations at 362 and 364 may be skipped. Otherwise, when the eSIM subscription manager server 306 transfers the eSIM hosted by the eUICC 310 of the source device 302 to the eUICC 316 of the target device 304, the eUICC 310 of the source device 302 may delete its eSIM at 362 and, at 364, the AP 308 of the source device 302 may transmit a deletion receipt to the eSIM subscription manager server 306. In some cases, the eSIM subscription manager server 306 may be prohibited from transferring an eSIM from the source device 302 to the target device 304 until it receives a deletion receipt.

After receiving the eSIM subscription transfer activation code at 366, the AP 314 of the target device 304 may transmit the eSIM subscription transfer activation code to the eSIM subscription manager server 306 at 366. The eSIM subscription transfer activation code may be transmitted via a transceiver of the target device 304. In some cases, the target device 304 may also transmit target device information, such as an EID of the target device 304 (and more particularly, an EID of the eUICC 316) to the eSIM subscription manager server 306. The target device information may be transmitted with the eSIM subscription transfer activation code or in a separate message. When the target device 304 also transmits target device information (e.g., the EID of the eUICC 316) to the eSIM subscription manager server 306, the eSIM subscription manager server 306 may verify the target device information (e.g., the EID of the eUICC 316) at 368. For example, the eSIM subscription manager server 306 may ensure that the EID received from the target device 304 matches an EID of the target device 304 received from the source device 302 at 338. At least partly in response to receiving the eSIM transfer activation code at 366, and in some cases at least partly in response to successfully verifying the target device information (e.g., the EID of the eUICC 316) at 368, the eSIM subscription manager server 306 may transmit a request for a confirmation code to the target device 304 at 370.

At 372, the target device 304 may prompt a user of the target device 304 for the confirmation code. Upon receiving the confirmation code, and at 374, the secure processor subsystem 318 of the target device 304 may generate a hash of the confirmation code. Alternatively, the operations at 372 and 374 may be replaced by the secure processor subsystem 318 generating pseudo-random data in accord with a predetermined algorithm. At 376, the processor system 312 of the target device 304 may transmit the hash of the confirmation code (or the pseud-random data) to the eSIM subscription manager server 306. The hash of the confirmation code (or pseudo-random data) may be transmitted via a transceiver of the target device 304.

At 378, the eSIM subscription manager server 306 may compare the hash of the confirmation code (or pseudo-random data) received from the source device at 354 (i.e., a first hash or first pseudo-random data) to the hash of the confirmation code (or pseudo-random data) received from the target device at 376 (i.e., a second hash or second pseudo-random data). At least partly in response to receiving the eSIM transfer activation code at 366, and at least partly in response to confirming a match of the second hash to the first hash (or confirming a match of the second pseudo-random data to the first pseudo-random data), the eSIM subscription manager server 306 may transmit an eSIM to the target device 304 at 380.

At 382, and subsequent to the eSIM being installed on or hosted by the eUICC 316, the AP 314 may request an eSIM subscription transfer certificate from the secure processor subsystem 318. At least partly in response to the request at 382, the secure processor subsystem 318 may generate the eSIM subscription transfer certificate. At 384, the secure processor subsystem 318 may transmit the eSIM subscription transfer certificate to the eUICC 316; and at 386, the eUICC 310 may sign the eSIM subscription transfer certificate.

At 388, the eUICC 316 of the target device 304 may transmit a receipt indicating the target device 304 installed the eSIM (e.g., an eSIM install receipt) to the eSIM subscription manager server 306. The install receipt may be transmitted via a transceiver of the target device 304. The eUICC 316 may also transmit the signed eSIM subscription transfer certificate.

At 390, the eSIM subscription manager server 306 may store the eSIM subscription transfer certificate. The eSIM subscription transfer certificate, generated by the secure processor subsystem 318 and signed by the eUICC 316, can be generated right after the eSIM is installed, at a time when the target device 304 is less likely to have been compromised.

At 392, and after receipt of the install receipt at 390, the eSIM subscription manager server 306 may optionally trigger ES2+service transfer (if a new ICCID was issued). Delaying ES2+service transfer until after the install receipt is received helps prevent a service conflict when duplicate service could potentially be provided through the simultaneous enablement of an eSIM installed on the source device 302 and a new eSIM installed on the target device 304.

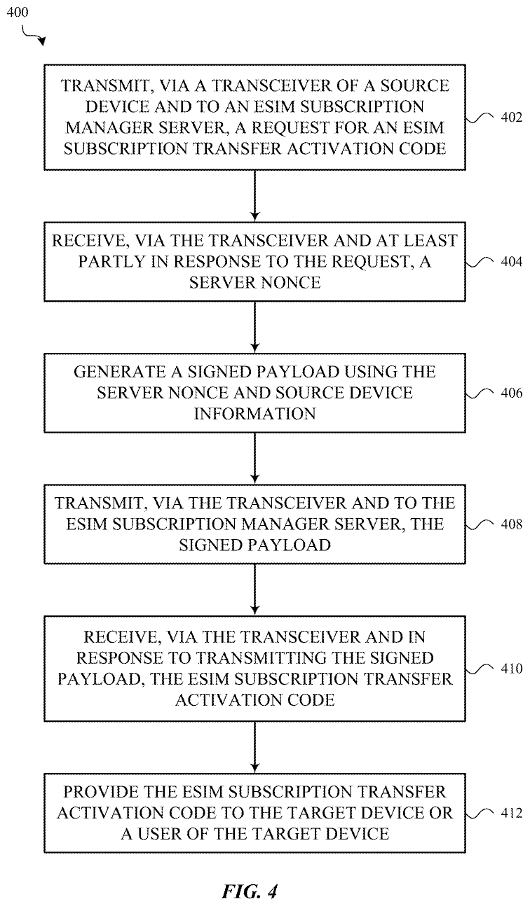

FIG. 4 illustrates a method 400 of a source device (e.g., a UE), for facilitating transfer of an eSIM subscription from the source device to a target device (e.g., another UE), according to an embodiment. The method 400 may be performed by a processor system of the source device, the processor system including an eUICC. The eUICC may be configured to store an eSIM associated with an eSIM subscription. At 402, the method 400 may include transmitting, via a transceiver of the source device and to an eSIM subscription manager server, a request for an eSIM subscription transfer activation code. At 404, the method 400 may include receiving, via the transceiver and at least partly in response to the request, a server nonce. At 406, the method 400 may include generating a signed payload using the server nonce and source device information (e.g., an ICCID of an eSIM hosted by an eUICC of the source device (i.e., the eSIM for which an eSIM subscription is to be transferred to the target device)) and, optionally, target device information (e.g., an EID of an eUICC of the target device). At 408, the method 400 may include transmitting, via the transceiver and to the eSIM subscription manager server, the signed payload. At 410, the method 400 may include receiving, via the transceiver and in response to transmitting the signed payload, the eSIM subscription transfer activation code. At 412, the method 400 may include providing the eSIM subscription transfer activation code to the target device or a user of the target device. The method 400 may include more, fewer, or alternative operations, as described with reference to any of FIGS. 1A-3C.

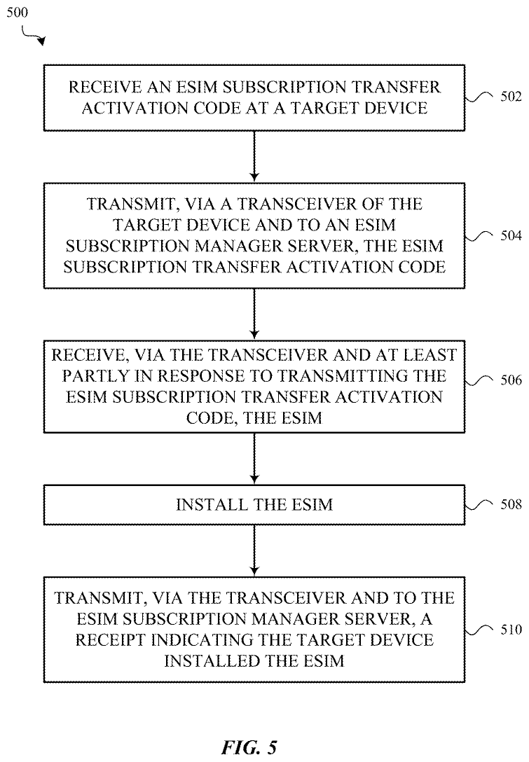

FIG. 5 illustrates a method 500 of a target device (e.g., a UE), for facilitating transfer of an eSIM subscription from a source device (e.g., another UE) to the target device, according to an embodiment. The method 500 may be performed by a processor system of the target device, the processor system including an eUICC. The eUICC may be configured to store an eSIM associated with an eSIM subscription. At 502, the method 500 may include receiving an eSIM subscription transfer activation code (e.g., from the source device). At 504, the method 500 may include transmitting, via the transceiver and to an eSIM subscription manager server, the eSIM subscription transfer activation code. At 506, the method 500 may include receiving, via the transceiver and at least partly in response to transmitting the eSIM subscription transfer activation code, the eSIM. At 508, the method 500 may include installing the eSIM. At 510, the method 500 may include transmitting, via the transceiver and to the eSIM subscription manager server, a receipt indicating the target device installed the eSIM. The method 500 may include more, fewer, or alternative operations, as described with reference to any of FIGS. 1A-3C.

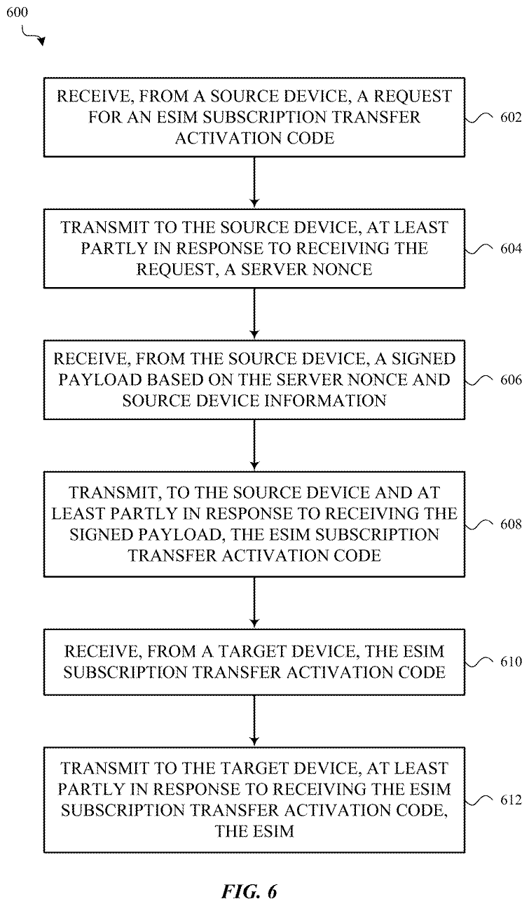

FIG. 6 illustrates a method 600 of an eSIM subscription manager server (e.g., an SM−DP+), for facilitating transfer of an eSIM subscription from a source device (e.g., a first UE) to a target device (e.g., a second UE), according to an embodiment. The method 600 may be performed by a processor system of the eSIM subscription manager server. At 602, the method 600 may include receiving, from a source device, a request for an eSIM subscription transfer activation code. At 604, the method 600 may include transmitting to the source device, and at least partly in response to receiving the request, a server nonce. At 606, the method 600 may include receiving, from the source device, a signed payload based on the server nonce and source device information. At 608, the method 600 may include transmitting, to the source device and at least partly in response to receiving the signed payload, the eSIM subscription transfer activation code. At 610, the method 600 may include receiving, from a target device, the eSIM subscription transfer activation code. At 612, the method 600 may include transmitting to the target device, at least partly in response to receiving the eSIM subscription transfer activation code, the eSIM. The method 600 may include more, fewer, or alternative operations, as described with reference to any of FIGS. 1A-3C.

Embodiments contemplated herein include an apparatus having means to perform one or more elements of the flow or method 400, 500, or 600. In the context of flow or method 400 or 500, this apparatus may be, for example, an apparatus of a UE (such as a wireless device 702, 704, or 802 that is a UE, as described herein). In the context of flow or method 600, this apparatus may be, for example, an apparatus of an eSIM subscription manager server (e.g., a server of a core network (CN) 724 or an application server 730, as described herein).

Embodiments contemplated herein include one or more non-transitory computer-readable media storing instructions to cause an electronic device, upon execution of the instructions by one or more processors of the electronic device, to perform one or more elements of the flow or method 400, 500, or 600. In the context of flow or method 400 or 500, this non-transitory computer-readable media may be, for example, a memory of a UE (such as a memory 806 of a wireless device 702, 704, or 802 that is a UE, as described herein). In the context of flow or method 600, this non-transitory computer-readable media may be, for example, a memory of an eSIM subscription manager server (such as a memory of a CN 724 or an application server 730, as described herein).

Embodiments contemplated herein include an apparatus having logic, modules, or circuitry to perform one or more elements of the flow or method 400, 500, or 600. In the context of flow or method 400 or 500, this apparatus may be, for example, an apparatus of a UE (such as a wireless device 702, 704, or 802 that is a UE, as described herein). In the context of flow or method 600, this apparatus may be, for example, an apparatus of an eSIM subscription manager server (e.g., a server of a core network (CN) 724 or an application server 730, as described herein).

Embodiments contemplated herein include an apparatus having one or more processors and one or more computer-readable media, using or storing instructions that, when executed by the one or more processors, cause the one or more processors to perform one or more elements of the method 400, 500, or 600. In the context of flow or method 400 or 500, this apparatus may be, for example, an apparatus of a UE (such as a wireless device 702, 704, or 802 that is a UE, as described herein). In the context of flow or method 600, this apparatus may be, for example, an apparatus of an eSIM subscription manager server (e.g., a server of a core network (CN) 724 or an application server 730, as described herein).

Embodiments contemplated herein include a signal as described in or related to one or more elements of the flow or method 400, 500, or 600.

Embodiments contemplated herein include a computer program or computer program product having instructions, wherein execution of the program by a processor causes the processor to carry out one or more elements of the flow or method 400, 500, or 600. In the context of flow or method 400 or 500, the processor may be a processor of a UE (such as a processor(s) 804 of a wireless device 702, 704, or 802 that is a UE, as described herein), and the instructions may be, for example, located in the processor and/or on a memory of the UE (such as a memory 806 of a wireless device 702, 704, or 802 that is a UE, as described herein). In the context of flow or method 600, the processor may be a processor of an eSIM subscription manager server (such as a processor of a CN 724 or an application server 730, as described herein), and the instructions may be, for example, located in the processor and/or on a memory of the eSIM subscription manager server (such as a memory of a CN 724 or an application server 730, as described herein).

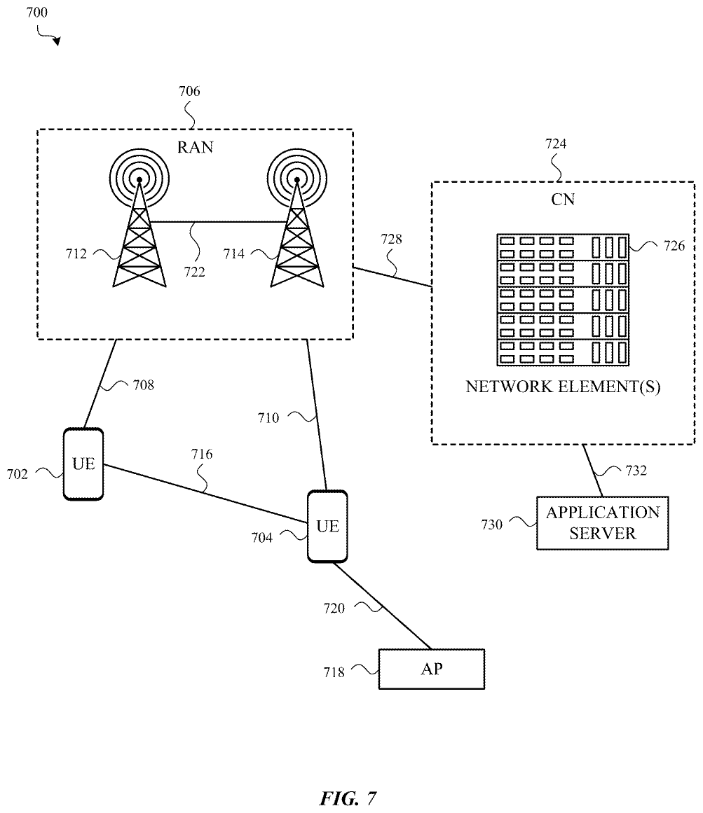

FIG. 7 illustrates an example architecture of a wireless communication system 700, according to embodiments disclosed herein. The following description is provided for an example wireless communication system 700 that operates in conjunction with the LTE system standards and/or 5G or NR system standards as provided by 3GPP technical specifications.

As shown by FIG. 7, the wireless communication system 700 includes UE 702 and UE 704 (although any number of UEs may be used). In this example, the UE 702 and the UE 704 are illustrated as smartphones (e.g., handheld touchscreen mobile computing devices connectable to one or more cellular networks), but may also comprise any mobile or non-mobile computing device configured for wireless communication. By way of example, the UE 702 and the UE 704 may be, respectively, the source device and the target device referred to in any of FIGS. 1A-6.

The UE 702 and UE 704 may be configured to communicatively couple with a RAN 706. In embodiments, the RAN 706 may be NG-RAN, E-UTRAN, etc. The UE 702 and UE 704 utilize connections (or channels) (shown as connection 708 and connection 710, respectively) with the RAN 706, each of which comprises a physical communications interface. The RAN 706 can include one or more base stations, such as base station 712 and base station 714, that enable the connection 708 and connection 710.

In this example, the connection 708 and connection 710 are air interfaces to enable such communicative coupling, and may be consistent with RAT(s) used by the RAN 706, such as, for example, an LTE and/or NR.

In some embodiments, the UE 702 and UE 704 may also directly exchange communication data via a sidelink interface 716. The UE 704 is shown to be configured to access an access point (shown as AP 718) via connection 720. By way of example, the connection 720 can comprise a local wireless connection, such as a connection consistent with any IEEE 802.11 protocol, wherein the AP 718 may comprise a Wi-Fi® router. In this example, the AP 718 may be connected to another network (for example, the Internet) without going through a CN 724.

In embodiments, the UE 702 and UE 704 can be configured to communicate using orthogonal frequency division multiplexing (OFDM) communication signals with each other or with the base station 712 and/or the base station 714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 712 or base station 714 may be implemented as one or more software entities running on server computers as part of a virtual network. In addition, or in other embodiments, the base station 712 or base station 714 may be configured to communicate with one another via interface 722. In embodiments where the wireless communication system 700 is an LTE system (e.g., when the CN 724 is an EPC), the interface 722 may be an X2 interface. The X2 interface may be defined between two or more base stations (e.g., two or more eNBs and the like) that connect to an EPC, and/or between two eNBs connecting to the EPC. In embodiments where the wireless communication system 700 is an NR system (e.g., when CN 724 is a 5GC), the interface 722 may be an Xn interface. The Xn interface is defined between two or more base stations (e.g., two or more gNBs and the like) that connect to 5GC, between a base station 712 (e.g., a gNB) connecting to 5GC and an eNB, and/or between two eNBs connecting to 5GC (e.g., CN 724).

The RAN 706 is shown to be communicatively coupled to the CN 724. The CN 724 may comprise one or more network elements 726, which are configured to offer various data and telecommunications services to customers/subscribers (e.g., users of UE 702 and UE 704) who are connected to the CN 724 via the RAN 706. The components of the CN 724 may be implemented in one physical device or separate physical devices including components to read and execute instructions from a machine-readable or computer-readable medium (e.g., a non-transitory machine-readable storage medium).

In embodiments, the CN 724 may be an EPC, and the RAN 706 may be connected with the CN 724 via an Si interface 728. In embodiments, the Si interface 728 may be split into two parts, an S1 user plane (S1-U) interface, which carries traffic data between the base station 712 or base station 714 and a serving gateway (S-GW), and the S 1-MME interface, which is a signaling interface between the base station 712 or base station 714 and mobility management entities (MMEs).

In embodiments, the CN 724 may be a 5GC, and the RAN 706 may be connected with the CN 724 via an NG interface 728. In embodiments, the NG interface 728 may be split into two parts, an NG user plane (NG-U) interface, which carries traffic data between the base station 712 or base station 714 and a user plane function (UPF), and the S1 control plane (NG-C) interface, which is a signaling interface between the base station 712 or base station 714 and access and mobility management functions (AMFs).

Generally, an application server 730 may be an element offering applications that use internet protocol (IP) bearer resources with the CN 724 (e.g., packet switched data services). The application server 730 can also be configured to support one or more communication services (e.g., VoIP sessions, group communication sessions, etc.) for the UE 702 and UE 704 via the CN 724. The application server 730 may communicate with the CN 724 through an IP communications interface 732.

In some embodiments, one of the network element(s) 726 may be or include an eSIM subscription manager server, such as the eSIM subscription manager server referred to in any of FIGS. 1A-6. Alternatively, the application server 730 may be or include an eSIM subscription manager server.

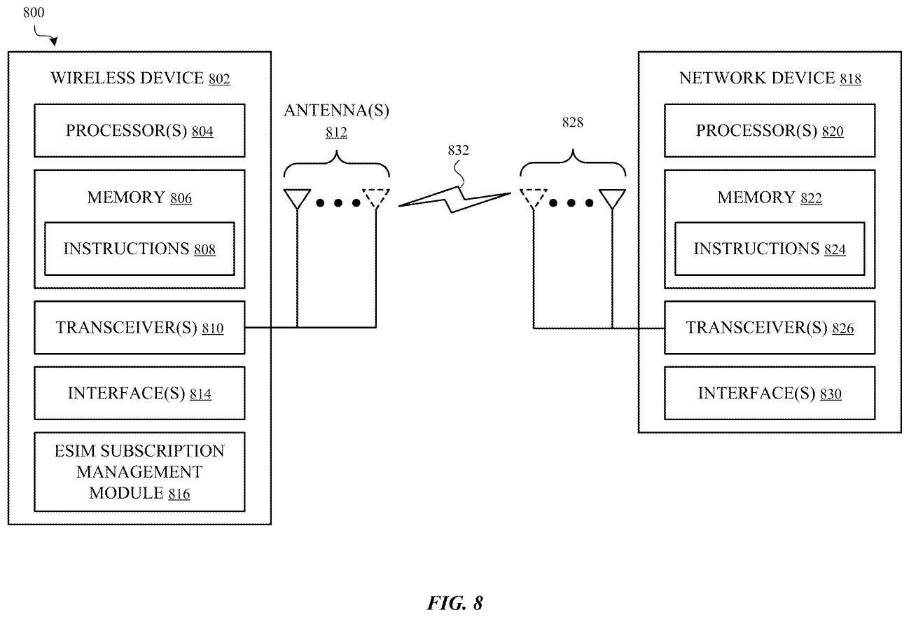

FIG. 8 illustrates a system 800 for performing signaling 832 between a wireless device 802 and a network device 818, according to embodiments disclosed herein. The system 800 may be a portion of a wireless communications system as herein described. The wireless device 802 may be, for example, a UE of a wireless communication system. In some cases, the wireless device 802 may be the source device or target device referred to in any of FIGS. 1A-6. The network device 818 may be, for example, a base station (e.g., an eNB or a gNB) of a wireless communication system. The network device 818 may provide a means of facilitating communication between the wireless device 802 and an eSIM subscription manager server.

The wireless device 802 may include one or more processor(s) 804. The processor(s) 804 may execute instructions such that various operations of the wireless device 802 are performed, as described herein. The processor(s) 804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 802 may include a memory 806. The memory 806 may be a non-transitory computer-readable storage medium that stores instructions 808 (which may include, for example, the instructions being executed by the processor(s) 804). The instructions 808 may also be referred to as program code or a computer program. The memory 806 may also store data used by, and results computed by, the processor(s) 804.

The wireless device 802 may include one or more transceiver(s) 810 that may include radio frequency (RF) transmitter and/or receiver circuitry that use the antenna(s) 812 of the wireless device 802 to facilitate signaling (e.g., the signaling 832) to and/or from the wireless device 802 with other devices (e.g., the network device 818) according to corresponding RATs.

The wireless device 802 may include one or more antenna(s) 812 (e.g., one, two, four, or more). For embodiments with multiple antenna(s) 812, the wireless device 802 may leverage the spatial diversity of such multiple antenna(s) 812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 802 may be accomplished according to precoding (or digital beamforming) that is applied at the wireless device 802 that multiplexes the data streams across the antenna(s) 812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 802 may implement analog beamforming techniques, whereby phases of the signals sent by the antenna(s) 812 are relatively adjusted such that the (joint) transmission of the antenna(s) 812 can be directed (this is sometimes referred to as beam steering).

The wireless device 802 may include one or more interface(s) 814. The interface(s) 814 may be used to provide input to or output from the wireless device 802. For example, a wireless device 802 that is a UE may include interface(s) 814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 810/antenna(s) 812 already described) that allow for communication between the UE and other devices and may operate according to known protocols (e.g., Wi-Fi®, Bluetooth®, and the like).

The wireless device 802 may include an eSIM subscription management module 816. The eSIM subscription management module 816 may be implemented via hardware, software, or combinations thereof. For example, the eSIM subscription management module 816 may be implemented as a processor, circuit, and/or instructions 808 stored in the memory 806 and executed by the processor(s) 804. In some examples, the eSIM subscription management module 816 may be integrated within the processor(s) 804 and/or the transceiver(s) 810. For example, the eSIM subscription management module 816 may be implemented by a combination of software components (e.g., executed by a DSP or a general processor) and hardware components (e.g., logic gates and circuitry) within the processor(s) 804 or the transceiver(s) 810.

The eSIM subscription management module 816 may be used for various aspects of the present disclosure, for example, aspects of FIGS. 1A-6. The eSIM subscription management module 816 may be configured to, for example, facilitate a transfer of an eSIM subscription from (or to) the wireless device 802.

The network device 818 may include one or more processor(s) 820. The processor(s) 820 may execute instructions such that various operations of the network device 818 are performed, as described herein. The processor(s) 820 may include one or more baseband processors implemented using, for example, a CPU, a DSP, an ASIC, a controller, an FPGA device, another hardware device, a firmware device, or any combination thereof configured to perform the operations described herein.

The network device 818 may include a memory 822. The memory 822 may be a non-transitory computer-readable storage medium that stores instructions 824 (which may include, for example, the instructions being executed by the processor(s) 820). The instructions 824 may also be referred to as program code or a computer program. The memory 822 may also store data used by, and results computed by, the processor(s) 820.

The network device 818 may include one or more transceiver(s) 826 that may include RF transmitter and/or receiver circuitry that use the antenna(s) 828 of the network device 818 to facilitate signaling (e.g., the signaling 832) to and/or from the network device 818 with other devices (e.g., the wireless device 802) according to corresponding RATs.

The network device 818 may include one or more antenna(s) 828 (e.g., one, two, four, or more). In embodiments having multiple antenna(s) 828, the network device 818 may perform MIMO, digital beamforming, analog beamforming, beam steering, etc., as has been described.

The network device 818 may include one or more interface(s) 830. The interface(s) 830 may be used to provide input to or output from the network device 818. For example, a network device 818 that is a base station may include interface(s) 830 made up of transmitters, receivers, and other circuitry (e.g., other than the transceiver(s) 826 and antenna(s) 828 already described) that enables the base station to communicate with other equipment in a core network, and/or that enables the base station to communicate with external networks, computers, databases, and the like for purposes of operations, administration, and maintenance of the base station or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A source device, comprising:
a transceiver; and
a processor system including an embedded universal integrated circuit card (eUICC), the eUICC configured to store an embedded subscriber identity module (eSIM) associated with an eSIM subscription, the processor system configured to facilitate transfer of the eSIM subscription, from the source device to a target device by,
transmitting, via the transceiver and to an eSIM subscription manager server, a request for an eSIM subscription transfer activation code;
receiving, via the transceiver and at least partly in response to the request, a server nonce;
generating a signed payload using the server nonce and source device information;
transmitting, via the transceiver and to the eSIM subscription manager server, the signed payload;
receiving, via the transceiver and in response to transmitting the signed payload, the eSIM subscription transfer activation code; and
providing the eSIM subscription transfer activation code to the target device or a user of the target device.

2. The source device of claim 1, wherein:
the processor system is configured to,
receive target device information; wherein,
the signed payload is further generated using the target device information.

3. The source device of claim 2, wherein:
the target device information includes an embedded identity document (EID) of the target device; and
the source device information includes an integrated circuit card identifier (ICCID) of the source device.

4. The source device of claim 2, further comprising:
at least one of a short-range wireless communication transceiver or a camera; wherein,
the processor system is configured to,
obtain the target device information by operating the short-range wireless communication transceiver or the camera.

5. The source device of claim 1, wherein:
the processor system is configured to,
prompt a user of the source device for a confirmation code;
generate a hash of the confirmation code at the eUICC; and
transmit, via the transceiver and to the eSIM subscription manager server, with the signed payload, the hash of the confirmation code.

6. The source device of claim 1, wherein:
the processor system is configured to,
at the eUICC, generate pseudo-random data in accord with a predetermined algorithm;
transmit, via the transceiver and to the eSIM subscription manager server with the signed payload, the pseudo-random data; and
provide the pseudo-random data to the target device.

7. The source device of claim 1, wherein the processor system includes a secure processor subsystem, separate from the eUICC.

8. The source device of claim 7, wherein:
the processor system is configured to, prior to facilitating transfer of the eSIM subscription from the source device to the target device, perform at least two of more of:
generating the signed payload;
requesting the eSIM;
generating, by the secure processor subsystem, an eSIM subscription transfer certificate;
signing, by the eUICC, the eSIM subscription transfer certificate; and
transmitting, via the transceiver and to the eSIM subscription manager server, the signed eSIM subscription transfer certificate.

9. The source device of claim 1, wherein:
the processor system is configured to,
prompt the user for a mechanical input; and
generate the signed payload at least partly in response to receiving the mechanical input.

10. A target device, comprising:
a transceiver; and
a processor system including an embedded universal integrated circuit card (eUICC), the eUICC configured to store an embedded subscriber identity module (eSIM) associated with an eSIM subscription, the processor system configured to facilitate transfer of the eSIM subscription, from a source device to the target device by,
receiving an eSIM subscription transfer activation code;
transmitting, via the transceiver and to an eSIM subscription manager server, the eSIM subscription transfer activation code;
receiving, via the transceiver and at least partly in response to transmitting the eSIM subscription transfer activation code, the eSIM;
installing the eSIM; and
transmitting, via the transceiver and to the eSIM subscription manager server, a receipt indicating the target device installed the eSIM.

11. The target device of claim 10, wherein:
the processor system is configured to,
transmit, via the transceiver and to the source device, prior to receiving the eSIM, an embedded identity document (EID) of the target device.

12. The target device of claim 10, wherein:
the processor system is configured to,
receive, via the transceiver and at least partly in response to the request for the eSIM, a request for a confirmation code;
prompt a user of the target device for the confirmation code;
generate a hash of the confirmation code at the eUICC; and
transmit, via the transceiver and to the eSIM subscription manager server, the hash of the confirmation code; wherein,
the eSIM is received at least partly in response to the transmission of the hash of the confirmation code.

13. The target device of claim 10, wherein:
the processor system is configured to,
receive, via the transceiver and at least partly in response to the request for the eSIM, a request for a confirmation code;
at the eUICC, generate pseudo-random data in accord with a predetermined algorithm; and
transmit, via the transceiver and to the eSIM subscription manager server, the pseudo-random data; wherein,
the eSIM is received at least partly in response to the transmission of the pseudo-random data.

14. The target device of claim 10, wherein:
the processor system includes a secure processor subsystem, separate from the eUICC; and
the processor system is configured to, after receiving the eSIM,
generate, by the secure processor subsystem, an eSIM subscription transfer certificate;
sign, by the eUICC, the eSIM subscription transfer certificate; and
transmit, via the transceiver and to the eSIM subscription manager server, the signed eSIM subscription transfer certificate.

15. A method of wireless communication at an embedded subscriber identity module (eSIM) subscription manager server, comprising:
receiving, from a source device, a request for an eSIM subscription transfer activation code;
transmitting to the source device, at least partly in response to receiving the request, a server nonce;
receiving, from the source device, a signed payload based on the server nonce and source device information;
transmitting, to the source device and at least partly in response to receiving the signed payload, the eSIM subscription transfer activation code;
receiving, from a target device, the eSIM subscription transfer activation code; and
transmitting to the target device, at least partly in response to receiving the eSIM subscription transfer activation code, the eSIM.

16. The method of claim 15, further comprising:
receiving, from the target device, a receipt indicating the target device installed the eSIM.

17. The method of claim 16, further comprising:
receiving, with the receipt, an eSIM subscription transfer certificate signed by the target device.

18. The method of claim 15, wherein:
the signed payload is further based on target device information;
the method further comprises:
receiving, from the target device and with the eSIM subscription transfer activation code, the target device information; and
verifying the target device information on which the signed payload is based matches the target device information received from the target device; and
the eSIM is transmitted to the target device at least partly in response to the verification.

19. The method of claim 18, wherein:
the target device information includes an embedded identity document (EID) of the target device; and
the source device information includes an integrated circuit card identifier (ICCID) of the source device.

20. The method of claim 15, further comprising:
receiving from the source device, with the signed payload, a first hash of a confirmation code;
transmitting, to the target device and at least partly in response to receiving the eSIM subscription transfer activation code from the target device, a request for the confirmation code;
receiving a second hash of the confirmation code; and
confirming a match of the second hash to the first hash; wherein,
the eSIM is transmitted to the target device at least partly in response to confirming the match of the second hash to the first hash.
